(19) United States
(12) Patent Application Publication
(10) Pub. No.: US 2006/0106690 A1
(43) Pub. Date: May 18, 2006

(54) Lender evaluation system

(75) Inventors: Chris Williard, Archdale, NC (US); Rick Hughes, Reidsville, NC (US); Brian Roberts, Winston-Salem, NC (US); Beverly Lentz, Oak Ridge, NC (US); Tim VonCannon, Winston-Salem, NC (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: American International Group, Inc., New York, NY (US)

(21) Appl. No.: 10/976,999

(22) Filed: Oct. 29, 2004

(51) Int. Cl. G06Q 40/00

(52) U.S. Cl. 705/35

(57) ABSTRACT

An automated system and method for evaluating and auditing lenders and loan portfolios is described. This lender evaluation system is user friendly and increases auditors' productivity by, among other things, gathering all necessary information in a readily accessible electronic location. The lender evaluation system, and associated methods, further reduce the risk of potential human error and the risk of lost data, and concomitantly improves data integrity.

### FIELD OF THE INVENTION

The present invention relates to a system and method for evaluating and auditing lenders and loan portfolios. The invention is particularly useful for guarantors or insurers of mortgage loans, or portions of such loans, that are issued by independent lenders.

### BACKGROUND OF THE INVENTION

In the typical mortgage loan process, an applicant will approach a lender or lenders to arrange financing for the purchase of property/to obtain an equity loan. Lenders, in response, typically require an applicant to complete a loan application, which includes information on the applicant's ability to make payments as well as the applicant's credit background and prior financial history. As part of the loan process, the lender also will inquire as to the applicant's investment in the property. For a variety of reasons, applicants who invest less than 20 percent in a particular piece of property pose more of a default risk to lenders than those with a greater interest in the property. As a result, many lenders require “mortgage insurance” for loans having a loan-to-value ratio of greater than 80 percent. In the event of a default, the insurer guarantees payment of the loan amount to the lender, thus lessening the risk of an adverse outcome to the lender if the mortgagor defaults.

Companies that provide insurance for lenders and loan portfolios are known as “mortgage insurers” or guarantors. Either by preexisting arrangement with the lender, or upon a specific request by the lender, the mortgage insurers underwrite a particular loan in exchange for a fee to be paid by the applicant or lender.

Each mortgage insurer sets its own quality assurance measurements and guidelines as to which loans it will or will not insure. Those applications that do not meet or exceed a mortgage insurer's requirements will be denied coverage. Lenders may send mortgage applications to more than one mortgage insurer. One company may approve an application, while another may not. Mortgage insurers also must comply with all applicable local, state and federal laws.

In certain instances, a mortgage insurer will “delegate” part or all of the underwriting process to a lender. In this trusted relationship, mortgage insurers provide coverage under the assumption that a lender has followed the established underwriting guidelines. Loans made by a lender, and insured by the mortgage insurer, are thus not underwritten by the guarantor at the time of receipt. However, because lenders and/or loan officers may not always adhere to the guidelines established by the mortgage insurers, it is necessary to audit the lenders and loan portfolios to verify compliance. Lenders that consistently fail to abide by the guidelines set by a mortgage insurer may be disallowed from future delegated business or may be subject to more strict scrutiny than those that consistently perform as required.

Prior art approaches to evaluating lenders and loan portfolios were manual and time-consuming. In one prior art approach, auditors manually query a database containing data on lenders and loan applications to obtain a large set of potential audit candidates. In a further manual process, the auditor would select a random sample of such loans for audit, and for each loan in the sample, calculate several risk factors, including debt ratios (also known as debt-to-income (DI) ratio; these ratios are calculated by dividing monthly debts by monthly income) and loan-to-value ratios (a cumulative loan-to-value ratio, also known as “CLTV,” is calculated by dividing the first lien balance plus the second/equity loan by the estimated value of the equity provided). The auditor further would manually compare actual credit scores with reported credit scores.

Because such calculations and comparisons were performed manually, the auditor potentially could miscalculate these factors. Moreover, the manual process could take several days to a week to complete because no system existed that presented the relevant data in an integrated manner. Using information that existed in different portions of a database, or different databases entirely, an auditor was required to create a manual log of relevant information to complete the audit.

After completion of the foregoing preliminary steps, i.e., determining loans to be audited and creating appropriate logs, the auditor would thereafter engage in the actual audit, including the steps of corresponding with the lender to request information relating to the loans under audit and gathering all other necessary information to conduct the audit. Completing the audit involved further manual and time-consuming steps, such as generating paper worksheets and electronic summaries, e.g., in Microsoft Word or Excel, and then preparing a final response letter.

Further complicating the audit process was the lack of simplified access to complete results of prior audits for comparison purposes. Although the final response letter and loan comments were maintained in an accessible location to auditors, the data and worksheets supporting the audit outcome were archived in microfilm in a separate location. In order to view prior results other than the loan comments sent back on a final response letter, an auditor would have to order microfilm and review it on a microfilm viewer. Due to the difficulty in accessing such information, auditors typically ordered prior audit files only when absolutely necessary and usually only if there were issues or questions from the lender.

In view of the foregoing, there exists a need for a more automated and integrated manner of auditing lenders and loan portfolios and for creating and maintaining a database of audit results.

### SUMMARY OF THE INVENTION

The inventive system and method eliminates much of the manual and time consuming operations described above. An audit conducted with the inventive system and method can be accomplished in a much more efficient and accurate manner than previously known. The possibility of human errors, including errors in calculations, is significantly diminished.

In a preferred embodiment, an integrated computer system, comprised of a customizable Microsoft Access application and a data warehouse, permits auditors to select sample loans for audit to insure compliance with quality assurance measurements and metrics. In a highly preferred embodiment, each lender is assigned a single master policy identification (ID), which ID may be used to track each loan. Data is “loaded” into the data warehouse electronically, e.g., through an interactive Internet application or through electronic data interchange, or manually.

In practice, an auditor seeking to conduct an audit runs the customizable application which, in turn, automatically queries the data warehouse to obtain a selection of possible loans to be audited. In response to the query, the data warehouse returns a data set to the application, which presents the results to the auditor in a user-friendly manner. The auditor thereafter selects, on a random or otherwise predetermined basis, the loans that will be audited. Data is then copied from the data warehouse to the Access application for the selected loans to audit.

In accordance with the invention, the system automatically creates loan worksheets for each loan as well as an online summary of the individual loan worksheets. Through the use of the customizable application and the mathematical operations of Microsoft Access, the invention eliminates the manual calculations used in the prior art solutions. Worksheets may further be automatically created for each loan as information is entered into the database.

In a further aspect of the invention, audit request letters to lenders and other correspondence are automatically created. The invention uses preexisting letter templates in order to automatically populate contact names and address into letters to be printed. The auditor need only select the sample loans to audit, and the system thereafter automatically creates the needed worksheets, logs and correspondence with lenders.

In yet another aspect of the invention, auditors on a field audit may run a separate function that creates a new file that may be exported to a remote application. This remote application eliminates the risk of lost data during travel. The data can be transported back to the main application during travel via email. It further permits management to review, on a daily basis, the progress of audits.

Information generated during the course of an audit is tracked and stored in a centralized location. Auditors and other authorized personnel may thereafter easily access the complete file from prior audits, which eliminates the need to rely on microfilm. An online “journal” is further maintained for each lender, and auditors or company management may review each journal to review the progress of an in-progress audit, to document conversations with lenders, and to note risk factors for future audits.

The inventive system and method further provides extensive reporting capabilities that did not exist, and in some instances, could not exist in the prior art. In one aspect of the preferred embodiment, the system flags “Low Volume” and “No Activity” reports that permits the mortgage insurer to readily separate and maintain lenders with little or no volume (“low volume” occurs where a lender has had insufficient delegated business to warrant an audit, whereas “no volume” indicates the lender has submitted no delegated volume for three consecutive months) from those that submit a larger amount of business. An advantage of this report is that lower volume lenders are not inadvertently overlooked by the mortgage insurer's audit team.

The invention also assists auditors in conducting any needed follow-up in conjunction with the audit. It includes a follow-up tool that presents an auditor with a task list and other docket management information.

### BRIEF DESCRIPTION OF THE DRAWINGS

FIG. 1 is a block diagram illustrating an exemplary computer network.

FIG. 2 is a block diagram illustrating an exemplary computer.

FIGS. 3-14, inclusive, are screenshots of an exemplary user interface that interactively queries and/or displays information to auditors and further permits such individuals to input and update information.

### DETAILED DESCRIPTION OF THE INVENTION

The present invention may be implemented by programming code modules that are executed by a computer. Generally, program modules include routines, objects, components, data structures and the like that perform particular tasks or implement particular abstract data types. The terms “program” and “module” as used herein may connote a single program module or multiple program modules acting in concert. The invention may be implemented on a variety of types of computers, including personal computers (PCs) and, network PCs.

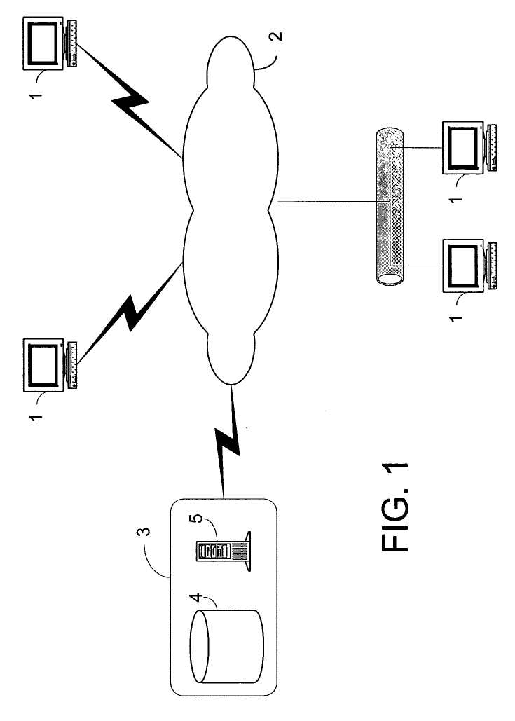

An example of a networked environment in which the invention may be employed will now be described with reference to FIG. 1. The example network includes several computers 1 communicating with one another over a network 2, represented by a cloud. Network 2 may include many well-known components, such as routers, gateways, hubs, etc. and may allow the computers 1 to communicate via wired and/or wireless media.

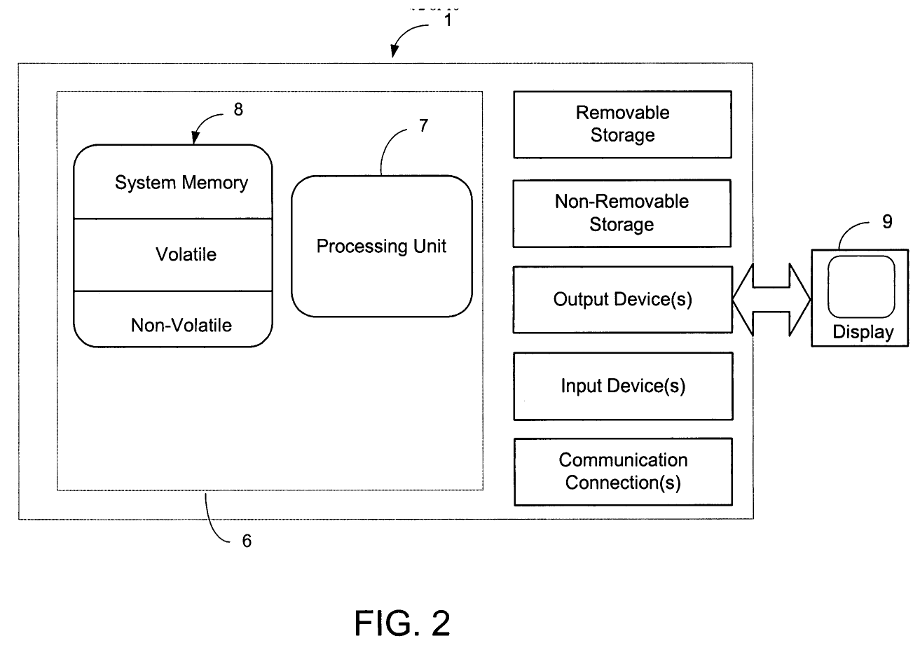

Referring to FIG. 2, an example of a basic configuration for a computer 1 on which the system described herein may be implemented is shown. In its most basic configuration, the computer 1 typically includes at least one processing unit 7 and memory 8. Depending on the exact configuration and type of the computer 1, memory 8 may be volatile (such as RAM), non-volatile (such as ROM or flash memory) or some combination of the two. This most basic configuration is illustrated in FIG. 2 by line 6. Additionally, the computer may also have additional features/functionality. For example, computer 1 may also include additional storage (removable and/or non-removable) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the computer 1. Any such computer storage media may be part of computer 1.

Computer 1 may also contain communications connections that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Computer 1 may also have input devices such as a keyboard, mouse, pen, voice input device, touch input device, etc. Output devices such as a display 9, speakers, a printer, etc. may also be included. All these devices are well known in the art and need not be discussed at length here.

The inventive system and method involves the processing of data, and, as such, includes a data processor and a data warehouse. FIG. 1 schematically illustrates these elements at reference numeral 3. Data processor 5 includes the necessary hardware and software to process data. The database software can be any one of several known database engines, or their equivalents, as may be known to persons of skill in the art. In a preferred embodiment, the database software is Microsoft Access, which may be obtained through Microsoft Corporation of Redmond, Wash. However, depending on the amount of data to be processed, as well as the number of concurrent users, it may be desirable to use more powerful database software, such as Microsoft SQL Server, which also may be obtained through Microsoft Corporation. The relevant database software, such as Access or SQL Server, accesses data stored in data warehouse 4.

In a preferred embodiment, a Lender Evaluation System (“LES”) of the invention is a Microsoft Access-based software application that resides and operates in the memory 8 of an individual computer 1, such as those illustrated in FIGS. 1 and 2. In this embodiment, the LES obtains data from the data warehouse, but the database engine does not process data at a location remote from the computer executing the LES. Alternative embodiments, however, will be readily appreciated by persons of skill in the art. For example, it is possible to implement the LES through an information server that centrally processes data and publishes a result set that may be displayed by computer 1. This may be accomplished, for example, by a remote access information server that includes or queries a database engine, which in turn, accesses the relevant data. An advantage of a centrally located data processor is that an auditor may not require unique or special applications on the computer accessing the LES. Instead, the loan auditor may merely direct, for example, a generic web browser (through a uniform resource locator) to access an appropriate information service, such as a web server, which returns a user interface suitable for an LES interactive session with the auditor. The “back end” database software processes queries and other information desired by the auditor, and the information service returns the requested data in a form that may be displayed by the browser. Of course, as is well known in the art, information passed between the client and server computers may be encrypted for security purposes. As will be readily appreciated, a further advantage of this approach is that an audit may be performed without regard to special software on client machines.

In order to conduct an audit or review data relating to a particular lender, an auditor or other user (“user”) first launches the LES, whether as a separate stand-alone application or as an information server based application. In a preferred embodiment, the LES challenges the user to supply the necessary credentials to access the system, e.g., by requiring input of a username and/or password.

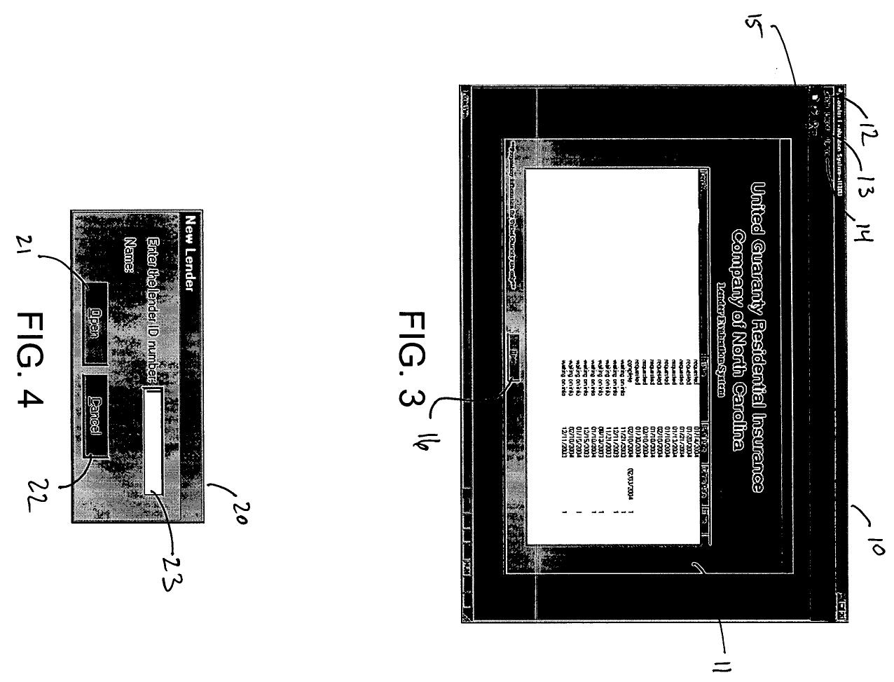

FIG. 3 illustrates a screenshot 10 of a page displayed on a computer 1 after a user has obtained access to the LES. As is illustrated, the LES returns information pertaining to specific lenders who currently have audits pending from either the current month or prior months or that have been requested or completed during the current month. The displayed data further includes the status of existing or contemplated audits, and the start and end dates of such audits.

As depicted at the top of the screen, the LES display a three “drop-down” options available to the user: a “Lender” menu item 12, a “Reports” menu item 13, and an “Options” menu item 14. The Reports menu item 13 displays a page (not shown) that allows the user to complete reports pertaining to information contained in the Lender Evaluation System, whereas the Options menu item 14 allows the user to customize the operation of the LES. There is also a “blank doc” button and “open folder” button that allow the user to perform the same tasks as clicking the “Lender” button. Introductory screen 10 further includes a “Close” button 15 and an “Open” button 16. Selection of the Close button 15 terminates a session, whereas selection of the Open button 16 causes the LES to open a selected audit item. The user selects a particular lender and/or audit item by moving the cursor to the item and clicking the open button 16. In screen shot 10, the names of actual lenders have been deleted for privacy purposes, but in practice, the names of such lenders will be displayed on the introductory screen.

The Lender menu item 12 typically includes at least two options, namely, one to add a new lender to the LES and the other to open a Lender account already present in the LES. When the user selects “add” under this hierarchy, the LES displays the interface 20 depicted in FIG. 4. Interface 20 presupposes the existence of a unique identifier for each Lender in the system, which is necessary for the orderly operation of the mortgage insurer. The user inputs this identifier into box 23, and the LES creates or updates the data associated with the lender and/or queries the user for information pertaining to the lender. After the data is input, the user clicks the “Open” button 21. It is also possible for the user to exit interface 20 by clicking the “Cancel” button 22.

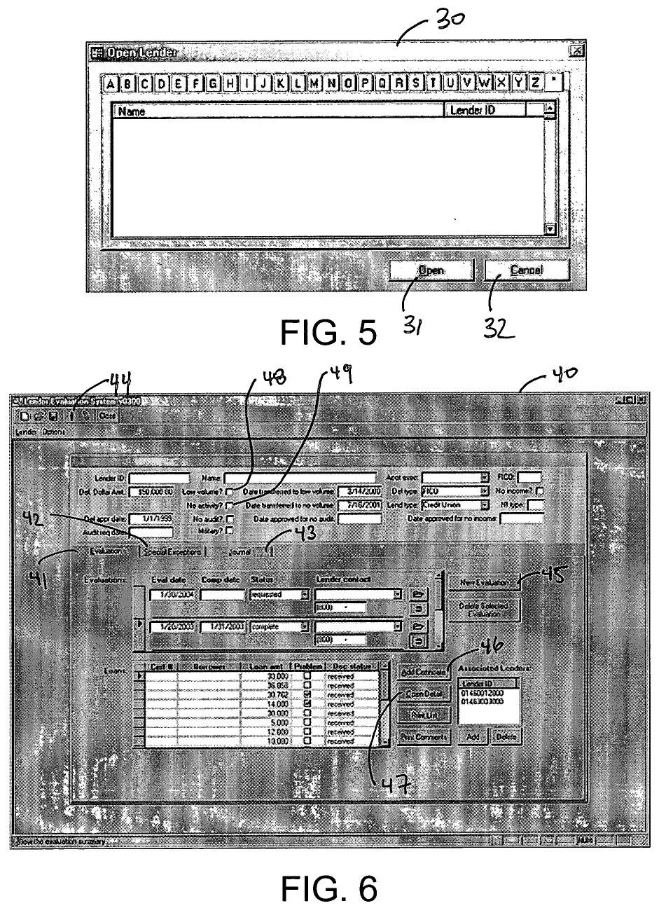

Upon selection of the option to open a particular lender's records, either by clicking Open button 21 or by selecting the open option from the Lender menu item 12, the LES displays interface 30 as indicated at FIG. 5. As with introductory screen 10, the names of actual lenders are not depicted in interface 30 for privacy purposes, but, in practice, the LES will actually populate this display with actual lender names. The user may then select the lender via an alphabetic listing by clicking the first letter in the lender's name. As with prior screens, interface 30 provides the user with an option to continue, by clicking the “Open” button 31, or to exit, by clicking the “Cancel” button 32.

Once an auditor or other user selects a lender or audit item to review, such as through the introductory screen 10 or interface 30, the LES displays a screen, such as exemplary screen 40, as depicted in FIG. 6. The top area of screen 40 displays certain characteristics of the lender, e.g., lender ID, name, account executive, delegated dollar amount, date approved for delegated business, type of lender, etc. The bottom area includes three folders: “Evaluation” folder 41, “Special Exceptions” folder 42, and “Journal” folder 43. There are also two windows and several other buttons that allow the user to access additional sections of the profile. Special Exceptions folder 42 displays the lender specific guideline exceptions from the application entry system, whereas Journal folder 43 allows the user to keep a follow-up journal of activity as it relates to a specific audit.

As depicted in FIG. 6, the top area of screen 40 shows a history of previously completed evaluations as well as requested and future evaluations. The interface further displays lender contact information, which is managed with the “person” button 44 on the top toolbar. By clicking this button, the user directs the LES to open an interface (not shown) that includes contact information for a particular lender. Once the information has been input or modified, the user may return to screen 40.

The bottom area of screen 40 depicts a list of loans requested for a particular evaluation from a particular lender. The displayed loans correspond to the evaluation date in the top window. Included on screen 40 are a series of additional buttons, which in turn lead to different screen displays and interfaces. An auditor uses the “New Evaluation” button 45 to create a new evaluation for a particular loan, the “Add Certificate” button 46 to add an insurance certificate associated with a particular loan, and the “Open Detail” button 47 to view the particulars of a selected loan. Screen 40 further includes buttons, which are depicted but not separately numbered, that allow a user to add or delete evaluations, add or delete associated lenders, print a list of loans to be evaluated and/or print comments.

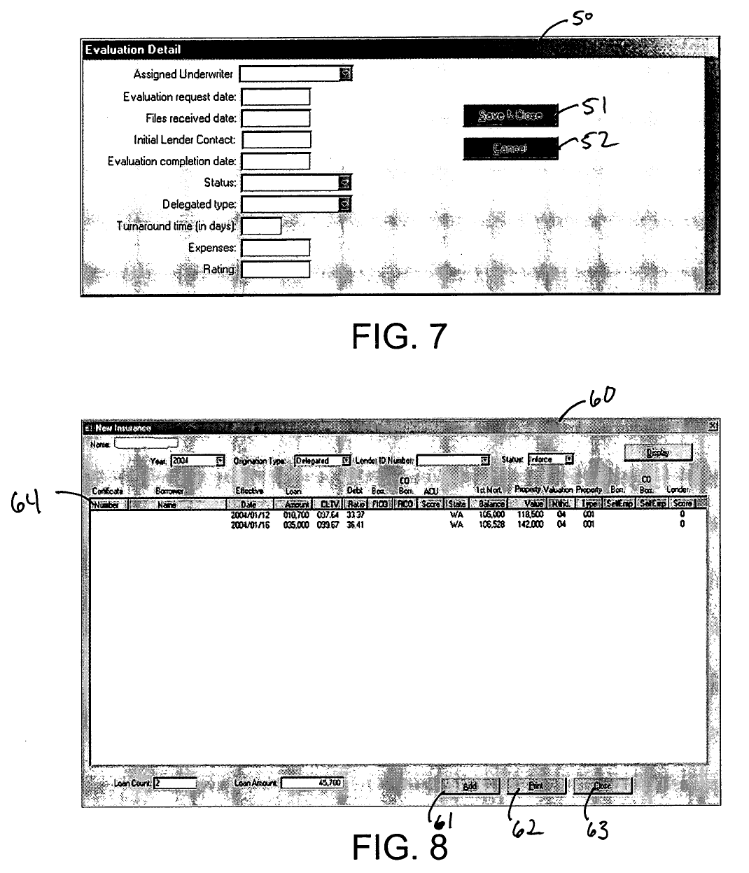

FIG. 7 illustrates the interface 50 presented to a user upon selection of the New Evaluation button 45 of screen 40. Through use of interface 50, an auditor may designate the assigned underwriter, dates relating to the completion of the evaluation, status, and/or generally create or modify the information associated with the evaluation as depicted. Interface 50 includes a “Save & Close” button 51, which allows a user to accept the changes made, or a “Cancel” button 52, which allows a user to end interface 50 without saving changes.

FIG. 8, in turn, illustrates the interface 60 presented to a user upon selection of the Add Certificate button 46 of screen 40. This interface permits a user to choose the insurance certificates for a particular evaluation or to add a certificate to the evaluation. The user selects a particular certificate number 64, which are not shown for privacy reasons, with the cursor and then clicks the “Add” button 61 at the bottom of interface 60. Upon clicking the “Close” button 63 on interface 60, the LES returns the user to screen 40. In addition, the auditor may print the insurance certificate information by clicking on “Print” button 62

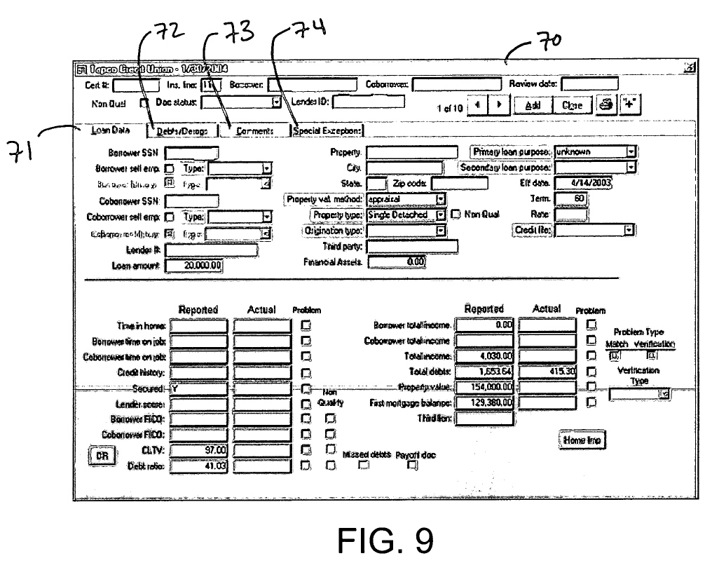

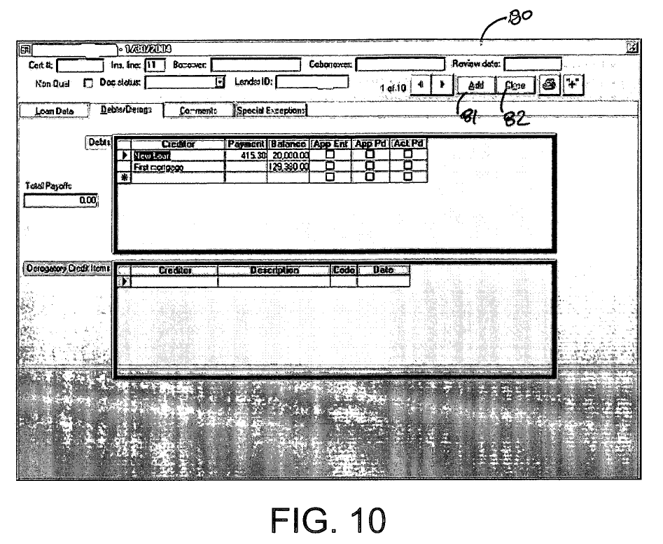

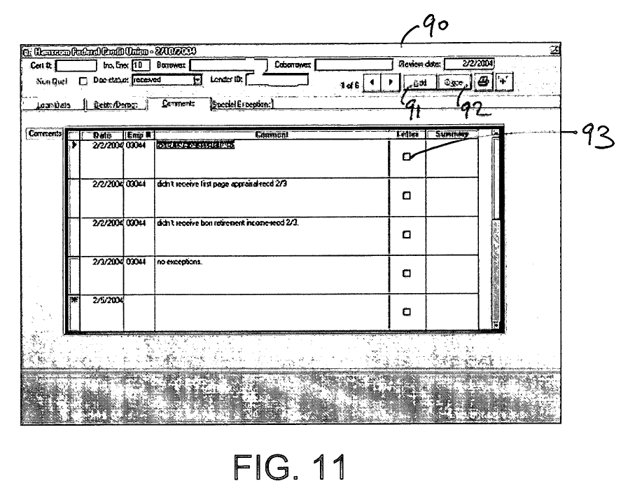

Upon selection of the Open Detail button 47 on screen 40, the LES presents a new interface 70 (an associated folder screen is illustrated in FIG. 9), which includes details regarding the evaluation. This interface includes three folder buttons, a “Loan Data” folder button 71 (an associated folder screen is illustrated in FIG. 9), a “Debts/Derogs” folder button 72 (an associated folder screen is illustrated in FIG. 10), and a “Comments” folder button 73 (an associated folder screen is illustrated in FIG. 11). Interface 70 further includes a Special Exceptions folder 74 (an associated folder screen is not shown) that captures information pertaining to an exception to the ordinary underwriting policy to which a lender or loan may be subject. In a preferred embodiment, the Special Exceptions screen (not shown) specifically displays the lender's exceptions from the application entry system, and displays the same information regardless of how the user accessed the screen. Interface 70 further includes a display of certain characteristics corresponding to a specific loan, such as certificate number, borrower's name, coborrower's name, date the loan was reviewed and the lender ID# for the policy the loan was insured under.

As illustrated in FIG. 9, the Loan Data screen associated with the Loan Data folder button 71 includes summary data pertaining to the load. The LES calculates and displays on this screen Debt Ratio and Combined LTV (“CLTV”) from the information entered in the Loan Data and Debts/Derogs screens (FIG. 10). The top of screen 70 further includes buttons, such as the left and right arrow buttons, that allow the user to navigate to different loans in the list. There is also a “print” button (shown as a printer icon) that allows the auditor to print the loan worksheet that pulls all this information into one printed page.

FIG. 10 depicts the screen/interface 80 associated with the Debts/Derogs folder button 72 on screen 70. Through this screen/interface, an auditor may input information to that the LES uses to calculate various information associated with a loan, such as CLTV. In addition, an auditor may input a narrative description of derogatory credit items and further provide a code for each such item. As with other displays, the screen/interface 80 includes arrow navigation buttons as well as an “Add” button 81, which permits a user to add a new certificate from the data warehouse, and a “Close” button 82, which permits the user to return to the prior screen display. FIG. 11 depicts a screen 90 that an auditor may use to include comments on a particular evaluation. Screen 90 is multi-functional in that it allows the user to enter comments that are kept on the system or printed on the worksheet. This screen also includes an “Add” button 91, which permits a user to add a new certificate from the data warehouse, and a “Close” button 92, which permits the user to return to the prior screen display. This screen further permits an auditor or other user to specify that a comment should print on a “comments sheet” that is printed from the Print Comments button on the lender profile screen. To do this the user would check the box, e.g., box 93, in the column labeled “Letter.” The last column labeled “Summary” is for the user to identify comments that will print on the final summary report. In the preferred embodiment, the LES presents a drop down menu of predetermined comments, e.g., debt ratio, documentation, income, or property, that appear once the auditor clicks inside the “Summary” column. This enables the auditor to catalog, by predetermined guideline areas, the issues in each comment.

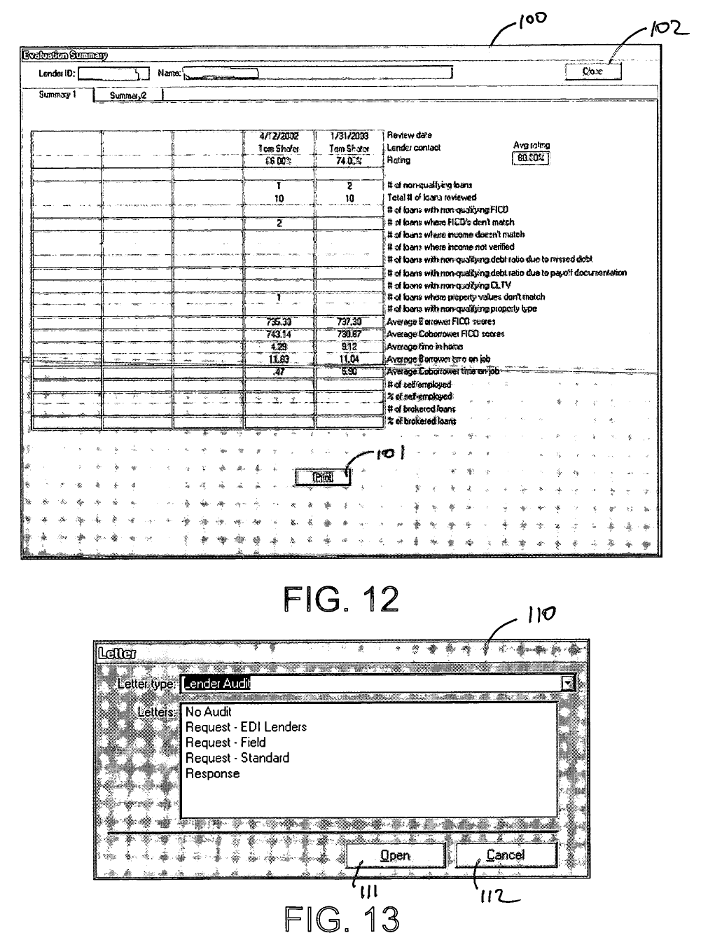

Upon completion of an evaluation, an auditor directs the LES to display a summary page 100, as depicted, for example, in FIG. 12. In this screen, the LES displays information pertaining to the lender, the number of loans processed and statistical data pertaining to the quality of the lender. In a preferred embodiment, the summary page 100 displays information from current and previous evaluations for comparison. The summary page provides a “Print” button 101 and a “Close” button 102. Upon selection of the print button, the LES prints a summary of the evaluation as well as any comments that were marked in the “Summary” section of the individual loan worksheets.

To more completely integrate the evaluation process, the LES further includes interfaces that assist the auditor to compose and print different letters for communicating with lenders. When an auditor invokes this functionality, the LES displays a first interface 110, as depicted in FIG. 13, which prompts the auditor to select the desired letter type, e.g., a no audit letter, a request for specific types of information, or a response. The auditor may thereafter generate a form letter by clicking the “Open” button 111 or exit to a prior screen by clicking the “Close” button 112.

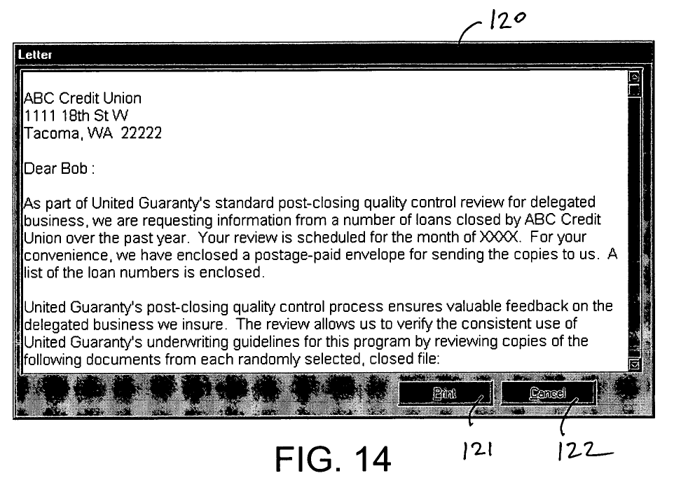

FIG. 14 depicts a screen 120, automatically generated by the LES, that reflects the text of a letter needed to advance the lender evaluation process. Based on the data input to the LES by the auditors or other users through, for example, the screens described above, the LES populates the fields of the letter and generates suitable text. Screen 120 further includes a “Print” button 121 and a “Cancel” button 122. An auditor may select the text in screen 120 and copy or save this information into a suitable word processor, such as Microsoft Word. The auditor may thus readily create and print the needed correspondence.

The inventive lender evaluation system and associated methods, as functionally described above, eliminates certain manual and time-consuming tasks. The LES tracks all delegated and package underwritten loans for all lenders based on a single unique identifier associated with each lender. The LES further permits a ready determination of which loans will be audited based on a review of multiple risk factors, as well as, loan closing dates. Correspondence required as part of the auditing process can be created from predetermined and stored letter templates.

The LES further creates a loan worksheet for each loan and an online summary from the individual loan worksheets. The system, as described above, makes the mathematical calculations, which eliminates the potential for human error. Worksheets relating to each loan are automatically created as the information is entered into the database. On a field audit, staff members can combine databases and export it via email to the home office to eliminate the risk of lost information during travel. This feature permits up-to-date oversight as to status of individual audits.

As described above, the LES further provides the means to track prior audit data and results for quick comparisons. This feature eliminates the necessity to rely on reviewing microfilm for reporting purposes. Online journals that are maintained for each lender in the LES track the progress of an audit, as it is being completed, and provide flags as to risk factors that may be helpful for future audits.

The reporting capabilities in the LES system supports the planning and scheduling of future audits and follow-ups. Among other things, the LES generates “Low Volume” and “No Activity” reports that allow auditors to separate and maintain the lenders with little or no volume from the ones that are actively submitting a larger amount of business. These reports are generated from information input to the LES by auditors, such as selecting check boxes 48 or 49 in screen 40 (FIG. 6). In addition, the LES creates and disseminates follow-up reports that are based on lenders' journals. Through these reports, the LES reminds underwriters as to follow-up calls that need to be made on a daily basis. A completed evaluation further provides information on audits completed during a specific time frame and can be broken down based on the type of lender.

While this invention has been described with an emphasis upon particular embodiments, it should be understood that the foregoing description has been limited to the presently contemplated best mode for practicing the invention. It will be apparent that various modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What is claimed is:

1. A method of evaluating lenders and loans, the method comprising the steps of:
querying an electronic database for information relating to loans made by a lender;
selecting a loan for evaluation from a screen display containing a listing of at least one loan issued by the lender;
electronically obtaining data relating to the loan (“loan data”), wherein a computer calculates certain of the loan data based on information stored in the electronic database;
reviewing the loan data to determine whether the loan conforms to predetermined guidelines;
entering data relating to the review of the loan data into the electronic database; and
generating correspondence directed to the lender, wherein a computer generates a portion of the correspondence based on information stored in the electronic database.

2. The method of claim 1, wherein the loan data includes both lender-reported data and verified data relating to the same aspect of a loan application.

3. The method of claim 2, wherein the lender-reported data is the credit score of a loan applicant as reported by the lender and the verified data is the credit score of a loan applicant as reported by a credit bureau.

4. The method of claim 2, wherein the lender-reported data is the income of a loan applicant as reported by the lender and the verified data is the income of a loan applicant as determined from records purporting to reflect the actual income of a loan applicant.

5. The method of claim 2, wherein the step of reviewing includes the step of comparing lender-reported data against verified data.

6. The method of claim 1, wherein the data calculated by the computer includes a cumulative loan to value ratio.

7. The method of claim 1 further comprising the step of generating a summary of the loans reviewed, wherein the summary is automatically generated by a computer based on data stored in the electronic database.

8. A graphical user interface for inputting, displaying and managing information relating to the evaluation of a lender, the graphical user interface comprising:
a loan selection screen that displays a list of loans made by one lender and permits a user to select a loan for further evaluation;
an evaluation screen that displays the status of a loan evaluation;
a loan data screen that displays data relating to a loan (“loan data”), wherein certain of the displayed loan data is calculated by a computer;
a data entry window that permits a user to enter data relating to whether the loan conforms to predetermined guidelines;
a comments screen that displays and permits the entry of user comments relating to a loan evaluation;
a correspondence screen that displays computer generated correspondence with the lender regarding the loan; and
a summary screen that displays a summary of evaluated loans for the lender.

9. The graphical user interface of claim 8, wherein the graphical user interface interacts with an electronic database.

10. The graphical user interface of claim 8, wherein the data entry window is located within the loan data screen.

11. The graphical user interface of claim 8, wherein the loan data calculated by the computer includes a cumulative loan to value ratio.

12. The graphical user interface of claim 8, wherein the summary includes information pertaining the number of loans reviewed and the number of loans that did not conform to the predetermined guidelines.

13. The graphical user interface of claim 8, wherein the predetermined guidelines include guidelines relating to a loan applicant's credit score, income, and debt.

14. A method for evaluating a lender's conformance with guidelines relating to the issuance of private mortgage insurance for property loans, the method comprising the steps of:
compiling data in an electronic database relating to loans issued by a lender;
selecting a loan application to be audited, wherein a computer calculates certain of the loan data to be used in the audit based on information stored in the electronic database;
auditing the loan against predetermined guidelines;
updating the data in the electronic database to reflect the result of an audit of a loan; and
generating and displaying an electronic summary of audits conducted on a plurality of loans issued by the lender.

15. The method of claim 14 further comprising the step of updating the data in the electronic database with progress notes regarding the status of each evaluation.

16. The method of claim 14, wherein a computer provides a user with a list of suitable loans to be audited.
